(19) United States
(12) Patent Application Publication
(10) Pub. No.: US 2006/0066553 A1
(43) Pub. Date: Mar. 30, 2006

(54) Active matrix display device with dc voltage compensation based on measurements on a plurality of measurement pixels outside the display area

(75) Inventor: Steven C Deane, Surrey (GB)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., EINDHOVEN (NL)

(21) Appl. No.: 10/539,200

(22) PCT Filed: Dec. 8, 2003
(86) PCT No.: PCT/IB03/05899

§ 371 Date: Jun. 17, 2005

(30) Foreign Application Priority Data
Dec. 19, 2002 (GB) 0229692.9

(51) Int. Cl. G09G 3/36

(52) U.S. Cl. 345/98

(57) ABSTRACT

An active matrix display device, particularly a liquid crystal display device, having an array of display pixels (25) driven with inverting polarity drive voltages includes correction means (40, 55) for providing a measurement indicative of a DC voltage level at the pixels (25), for example caused by kickback effects, and modifying pixel drive voltages accordingly so as to compensate for any display artefacts. The correction means includes a plurality of measurement pixels (40), each comprising one or more dummy display pixels, which are arranged at spaced locations along at least one side of the pixel array (45) and which supply independent measurements indicative of the behaviour of display pixels in their neighbourhood. The correction means is then able, for example, to account for variations in pixel DC levels over the array.

The present invention relates to an active matrix display device, and more particularly to display devices comprising an electro-optical material such as liquid crystal (LC) between two electrodes. Display devices of this type are typically used in televisions, computer monitors, and mobile telephones, for example.

A common display device of this form is an AMLCD (active matrix liquid crystal display). An example is described in U.S. Pat. No. 5,130,829, the contents of which are incorporated herein as reference material. In this device, an array of pixels is provided, arranged in rows and columns. Each pixel comprises a display element constituted by an electro-optic cell, which includes LC between two electrodes, and an associated switching device, typically a thin film transistor (TFT). The display element first electrodes are usually carried on one substrate together with the pixel TFTs and sets of row, selection, and column, data, address conductors connected to the pixel TFTs. The display element second electrodes are normally constituted by a common, counter, electrode carried on a second substrate which is spaced from the first substrate, with the LC material being disposed between the two substrates.

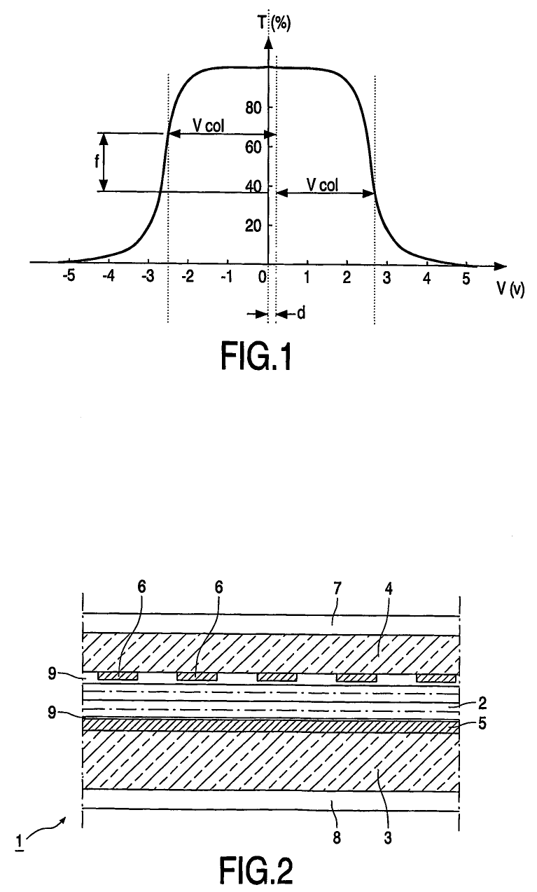

The display device is driven by applying alternating voltages to the array of pixels to produce a display image. Alternating voltages are used to avoid degradation of the electro-optical material. Each time a pixel is addressed (for each display frame), its display element is driven to the opposite polarity, that is, an inversion drive scheme is employed. The applied data voltage is inverted each time the pixel is selected resulting in the voltage across the LC display element changing polarity. However, it has been found that, for a number of reasons, a parasitic DC component may develop across the cells. This is particularly the case when the cells have an asymmetrical structure, as for example in reflective display devices where the device includes a reflector, or electrodes of the cells themselves are reflective. Kickback, the coupling of the gate (selection) pulse signal turn via the gate-drain capacitance of the TFT, and a phenomena well known in the art of AMLCDs, is another cause of a DC component across the cells. These DC components affect the display element voltage differently when a display element is charged to opposite polarities in successive frames. Thus, when the absolute value of the drive voltage applied to a display in successive frames is intended to be the same, the DC component will result in different absolute voltages evolving on the display element in each frame, leading to visible artefacts in the form of flicker and image sticking. FIG. 1 shows a plot of a display element's LC cell transmission T against the applied voltage V across the cell. It can be seen that the transmission is the same for opposite polarity voltages of equal magnitude. A parasitic DC component, or DC offset, d, is shown on the plot. The driving voltage Vcol applied by an associated column address conductor to the cell is therefore offset. For a positive frame, the magnitude of the voltage across the cell is Vcol+d. For a negative frame, the voltage magnitude across the cell is Vcol−d. It can be seen that the transmission levels for the opposite polarity frames for a given value of Vcol are different and vary by an amount, f %. Therefore, for a steady driving voltage of magnitude Vcol, the cell transmission will change by f % each frame period. This causes flicker at half the frame frequency.

To reduce the flicker exhibited in this way, it is well known to adjust the voltage applied across the cell. For example, this can be done by adjusting the voltage on the common, counter, electrode. Typically, in current manufacturing processes, the common electrode voltage levels of displays are adjusted manually to correct for flicker effects, which is a time-consuming and expensive process. Also, this does not compensate for changes of the parasitic DC component during the lifetime of the display, as may occur due to electrode ageing effects for example. Also, the magnitude of the DC component may change if the drive frequency of the display is changed. For example, the display device may have different modes of operation such as normal and low power modes which utilise different drive frequencies.

WO99/57706, the contents of which are incorporated herein by way of reference material, discloses a display device wherein the voltage across a display element outside the area used to display an image is measured. The control voltages for the display device are then adjusted in response to the measured voltage by circuitry included in the device to counteract flicker. A dummy row of pixels, functioning as a single measuring element, may be used rather than a single pixel. The effectiveness of this technique may be affected by the fact that the measured display element voltage swings rapidly over a wide range of values and the voltage measurement is susceptible to noise.

An alternative technique has been proposed in WO 2003/019520 (PHGB 020014) in which the correction means comprises a measurement pixel and means for generating for each of the voltage polarities applied across the electrodes of the display element cells a respective signal indicative of the capacitance of the measurement pixel cell, the correction means being arranged to modify voltages generated by the drive circuit in response to said signals. The capacitance of an electro-optical cell such as a LC display element is directly related to its transmissivity, whereas there may be a time lag between the application of a voltage across the display element and the LC moving to its final position in response thereto. Thus, measurement of the capacitance of the display element of a measurement pixel (rather than the voltages present across it as a result of normal addressing cycles) can provide a more accurate indication of the correction needed to counteract a parasitic DC component across the display elements and compensate for flicker.

This technique, like the previous technique, can also be used in achieving automatic correction for the effects of temperature variations. The threshold voltage levels and mobilities of TFTs (thin film transistors) commonly used as the pixel switching devices are both temperature dependent.

A dummy pixel outside the display pixel array is preferably used, the dummy pixel having the same electrical circuit as the actual display pixels. The use of a group of interconnected dummy pixels is suggested to provide scaling up and this is achieved by connecting the display element first electrodes of the dummy pixels together. This has the effect of increasing the size of the capacitance of the display element being measured which would allow a higher signal to noise ratio.

Whilst this technique offers an improvement it has been found also that there is a need for still further improvement, particularly with respect to comparatively large area and high resolution display devices.

According to the present invention, there is provided an active matrix display device comprising an array of pixels for producing a display output in response to drive voltages applied by drive circuit means, each pixel having a display element comprising electro-optical material between two electrodes and an associated switching device via which a drive voltage is applied to one electrode, the polarity of the voltage applied across the electrodes of each cell being periodically inverted, and correction means for providing a measurement indicative of a DC voltage level at the pixels and for modifying voltages applied by the drive circuit means in accordance therewith so as to compensate for display artefacts caused by the DC voltage level, the correction means comprising a plurality of measurement pixels located outside the area of the array of pixels producing the display output, the plurality of measurement pixels being arranged separate from one another at spaced locations along at least one side of the array and the correction means being arranged to provide a respective measurement from each of the measurement pixels.

The earlier proposed techniques assume that a DC voltage causing an unwanted display artefact will be substantially similar for all display pixels and that a measurement taken from a measurement pixel, either a single pixel or a group of interconnected pixels, will be representative of that level. However, this is not necessarily the case. In particular, in larger, high resolution types of AMLCD it has been found that different levels of kick back charge can be coupled into the pixels according to the position of the pixel along its row as a result of distortions to the row selection (gating) signal used to control the pixel switching devices when addressing the pixels. Such distortions are caused for example by the distributed capacitance and resistance of the row address conductor carrying this signal. The use of a plurality of separate measurement pixels distributed at spaced locations and able to provide independent measurements allows such variations in kick back levels to be measured and for adjustment of pixel drive signals to be suitably tailored to provide effective compensation. This results in substantially improved image quality, or alternatively, enables even larger display devices with acceptable display quality to be produced. This approach makes the display device self adjusting and also robust to processing variations. Such process variations, for example variations in the width of metal lines, layer thicknesses, and consequential metal layer sheet resistivity variations etc, can similarly lead to different kick back levels in pixels across the array.

The measurement pixels may be arranged along just one side of the array, for example along the upper or lower side of the array so as to provide an indication of pixel DC voltage level variations in the row direction. Preferably, measurement pixels are provided at least at opposing ends of the side of the array.

In a preferred embodiment, the measurement pixels are provided along both the top and bottom sides of the array.

Using just two measurement pixels located at each end of the upper or lower side of the array may provide adequate correction in some situations. One or more additional measurement pixels located between the two end measurement pixels can be beneficial to further improvement of image corrections, and will, for example, allow for automatic correction for other slowly varying causes of kick back variation, such as varying misalignment of features over the display pixel array area. The provision of measurement pixels at both the upper and lower sides of the array enables, for example, corrections for variations in kick back levels in the column direction over the display pixel array as well.

The correction means may be similar to those described in aforementioned WO99/57706 and WO 2003/019520, or other known kinds of correcting circuits suitable for measuring and counteracting kick back and other effects leading to DC voltage components in the pixels, such as that described in WO 2003/019509. In these the correction means is operable to modify drive voltages for the display pixels. In the case of an AMLCD using TFT switching devices and a common, counter, electrode shared by all pixels, the drive voltages modified may be the data voltages applied to the pixels via column address conductors and/or the voltage signal applied to the common electrode. In a two-level or a common electrode modulation drive scheme the adjustment might consist of the addition of an appropriate DC voltage to the common electrode. Such an adjustment would be inappropriate in the present invention as it would not permit the adjustment applied to be varied over the array. It may be feasible, however, to divide the common electrode into segments and adjust the voltage applied to each segment accordingly to enable some adjustment variations. Preferably, however, the adjustment is made to a drive voltage constituting the data signals. The outputs of measurement pixels at the ends of the side of the array can be used in the correction means for example in the case of a simple left-right, (row direction), variation to produce an offset of the data signal mean voltage in accordance with position along the row in the display array. Such adjustment can be readily implemented by digital processing of the incoming video signal from which the data signal are derived.

An embodiment of an active matrix display device, and in particular an AMLCD, in accordance with the present invention will now be described, by way of example, with reference to the accompanying schematic drawings, wherein:

FIG. 1 shows a graph of transmission against applied voltage for an LC cell constituting a typical LC display element;

FIG. 2 shows. highly simplified a transverse cross-sectional view of part of a LC display device;

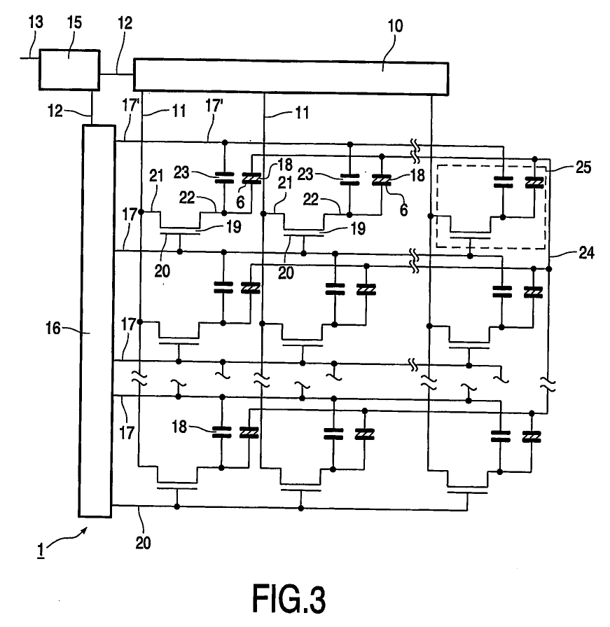

FIG. 3 shows a circuit diagram of an AMLCD; and

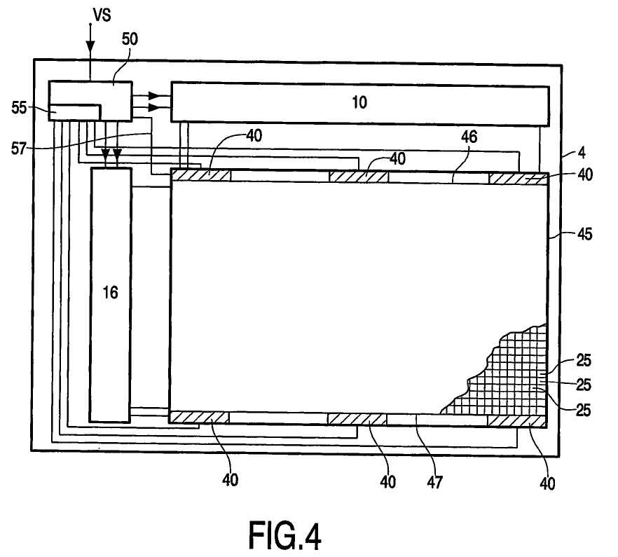

FIG. 4 shows schematically in plan an embodiment of display device according to the present invention.

The same reference numbers are used throughout the figures to denote the same or similar parts.

FIG. 2 is a cross-sectional view of part of a LC display device 1. Only a few pixels are illustrated for clarity. Twisted nematic LC material 2 is provided between two substrates 3,4 formed of glass, for example. An array of individual display element electrodes 6 is supported on one substrate 4, whilst a common, counter, electrode 5 is provided over the opposing surface of the other substrate 3. In a transmissive display for example, the electrodes 5 and 6 are formed of a transparent material, such as indium tin oxide (ITO). In a reflective type of display, the electrodes on only one substrate, typically the common electrode 5, need be transparent. Each display element electrode 6, an opposing portion of the common electrode 5 and the intervening LC material 2 together form an LC cell constituting a display element of a pixel. For a transmissive display, two polarisers, 7 and 8, are carried on the outer surfaces of respective substrates 3,4, with their directions of polarisation mutually perpendicular. For a reflective display only one polariser is required. Respective orientation layers 9 are provided over the display element and common electrodes 6,5 to orient the LC material 2 on the inner walls of the substrates 3,4. On application of a voltage across a pixel, the LC aligns itself in the resulting electric field, altering the transmissivity of the display element.

The main elements of a typical AMLCD are shown in FIG. 3. Each pixel 25 of the display comprises a switching element 19 and an LC cell 18. Each switching element is coupled to a respective one of a set of row or selection, address conductors 17 and a respective one of a set of column, or data, address conductors 11. The row conductors 17 are consecutively selected in respective row address periods by row selection signals generated by a row driver circuit 16 connected to each row conductor 17. The column conductors 11 are connected to a column driver circuit 10 which applies data signals thereto. If necessary, video data contained in a video signal inputted to the display device on an input line 13 is first processed by a timing and control unit 15. Data and synchronisation pulses are fed from the processor 15 to the row and column driver circuits 16,10 along drive lines 12.

The switching elements 19 in this case are TFTs. The gate electrode 20 of each TFT is electrically connected to a respective row conductor 17, the source electrode 21 thereof is electrically connected to a respective column conductor 11, and the drain electrode 22 thereof is electrically connected to the display element electrode 6 of the respective LC cell 18. When each TFT 19 in a row of pixels is selected by a row selection signal on the respective row conductor 17, the data signal voltage present at the corresponding column conductor 11 is transferred via the TFT 19 to the respective display element electrode. The pixels are driven such that the polarity of the voltage applied to the LC cells 18 is inverted every frame.

The display device of FIG. 3 includes an auxiliary, or storage, capacitor 23 for each pixel 25. The capacitor 23 is shown to be connected between the common point of the drain electrode 22 and the LC cell 18, and the row conductor 17 of the previous row of pixels. The first pixel row in the display, is provided with a supplementary row conductor 17′. In other configurations, the capacitor may be connected between said common point and a subsequent row electrode, or between said common point and a separate capacitor line.

The display device is constructed and operated generally in conventional manner and as such these aspects will not be described here in detail. For further details in these respects reference is invited to US-A-5130829.

As previously mentioned, display devices of this kind, in which the polarity of the drive voltages applied to display elements are periodically inverted, typically every frame, can suffer problems in the form of flicker caused by the development of a parasitic DC voltage component across the LC cells. This DC component may be the result of kick back effects, usually due to the falling edge of the row selection pulse used for addressing a row of pixels being coupled through the parasitic gate-drain capacitance of the pixel TFT. If present, the asymmetric nature of the LC cells, resulting from the opposing electrodes being of different materials in the case of a reflective type of display device, also contributes to the development of the unwanted DC component.

Examples of correction means intended to overcome this problem which provide a measurement indicative of the level of the DC component and adjust the drive voltages used for driving the pixels in accordance with the measurement to compensate, are described in the aforementioned specifications. These correction means use a measurement pixel comprising an LC cell and similar to those of the display array but located outside the area of the display array, or a group of such pixels interconnected with one another to assist the measurement operation. However, this approach will only provide a measurement of the electrical behaviour of one cell, or the average of a group of interconnected cells, and therefore any corrections applied to the array of display pixels on the basis of this measurement generally will be uniform over the pixel array.

An embodiment according to the present invention instead uses a plurality of separate measurement pixels which are located mutually spaced from one another along at least one side of the pixel array and which are operable to provide independent measurements. In this way a plurality of measurements indicative also of variations in the effects, for example, of kick back over the array can be obtained, enabling drive voltage adjustments to be made which take into account these variations, and thereby resulting in a higher quality image being produced.

FIG. 4 shows, highly schematically, a plan view of the AMLCD illustrating an example arrangement of the measurement pixels in an embodiment according to the invention. Here each block 40 represents a measurement pixel comprising a dummy pixel or a group of interconnected dummy pixels similar to the pixels 25 of the display array but located outside the area of the display array, here denoted at 45. These measurement pixels are fabricated simultaneously with those of the display array and consequently share similar characteristics to those pixels in the array to which they are closest. Each block 40 in this embodiment comprises a plurality of interconnected dummy pixels so as to improve signal to noise ratios for better measurement. As can be seen three such blocks are provided spaced along both the upper and lower sides 46, 47 of the pixel array with, at each of these sides, two blocks being located adjacent opposite ends of the side and the third being located approximately mid-way along the length of the side. The set of measurement pixels 40 along one side comprise respective portions of a row of dummy pixels, each portion consisting of a group of adjacent pixels.

The nature and cause of the variations in DC components levels produced across the pixel LC cells over the array will now be discussed. The distributed capacitance and resistance of the row conductors 17 results in a distortion by the row selection signal applied by the row driver circuit 16 to a conductor 17 along its length. This is particularly so in larger, high resolution devices and results in a significant difference in the shape of the gate pulse at the driven and undriven ends of the conductor 17, i.e the ends respectively neat to and remote from the circuit 16. This has consequences when the TFTs 20 of the pixels in the row are turned off, at the end of the row selection period. As the selection pulse signal travels along the row conductor 17 it is distorted by the combination of the row conductor resistance and the parasitic capacitive loads coupled to it. This means that although the signal may have fast rise and fall times near the driven end, the rise and fall times progressively deteriorate along the length of the conductor 17, becoming comparatively much slower at the end remote from the row driver circuit 16. The slow fall time results in the pixel TFTs 20 towards that remote end remaining in a conductive, on, state for longer than intended row address period so that some of the charge coupled into the pixels concerned by their parasitic gate/drain capacitance is conducted away. The change in gate pulse shape thus results in a difference in the level of kick back charge being coupled into the pixels with position along the pixel row and the resulting pixel charges therefore vary along the row, leading to display flicker and image sticking. The effect becomes worse if the row conductor resistance and capacitance increase, as happens in larger display devices, and also if the mobility of the TFTs 20 is increased.

Using an arrangement of measurement pixels 40 as shown in FIG. 4 the variation in kick-back can be measured and appropriate compensation made by suitably adjusting the column, data, voltage signals for display pixels according to their position along the row direction. The timing and control unit, here referenced at 50, which receives an external input video signal VS and which supplies data and timing signals to the column and row drive circuits 10 and 16 and a drive voltage signal to the common electrode (not shown) via a line 57, includes flicker correction processing means 55. Signals are sent between each group of dummy pixels constituting a respective measurement pixel 40 and the control circuit 55 indicative of the DC voltage component in the dummy pixels, and likewise the DC voltage in display pixels 25 in the region of the pixel array adjacent the measurement pixel 40. Thus, measurement signals obtained from the three measurement pixels 40 along the upper side of the array provide information regarding the variation of the DC component in pixels 25 along the row direction. The three measurement pixels 40 along the lower side of the pixel array provide information regarding the electrical characteristics of display pixels across the lower side of the array. Adjustment of the data signals by the correction processing means 50 may be based on the average outputs of the corresponding pairs of measurement pixels 40 at the upper and lower sides, assuming there is no cause for variations in pixel DC voltage components the vertical, column, direction.

The circuit 50 and for processing means 55 may be provided in ICs remote from those of the row and column driver circuits, or incorporated with them. Alternatively, these circuits may, together with the row and column driver circuits, be fully integrated on the substrate 4 carrying the active matrix circuitry, 11, 17, 20, and fabricated simultaneously therewith, using for example polysilicon technology, as illustrated in the embodiment of FIG. 4.

The use of measurement pixels 40 distributed around the pixel array, as shown in FIG. 4, to provide measurements indicative of the variation in kick back, with appropriate compensating adjustments to drive voltages then being made by the circuits 50 and 55, makes the display device self adjusting and robust to processing variations, such as metal line width variations, metal layer sheet resistivity variations, etc, which can occur when using thin film fabrication processes.

To provide measurements indicating the variation of kick back effects along the row direction a minimum of two measurement pixels would be required, preferably one at each end of either the upper or lower side of the pixel array. Further measuring pixels, as in the case of the FIG. 4 embodiment, provide improved correction and also allow for automatic adjustment of other slowly varying causes of kick back variation, such as varying misalignments over the pixel array area. More than three measurement pixels 40 may be provided for each side if desired.

The outputs of the measurement pixels are used to adjust the drive conditions. In the case of a simple left-right variation, this may result simply in an offset of the column mean voltage with position in the display, which can be implemented by digital processing of the incoming video signal. For ideal performance, this may require a small increase in the column voltage drive range. However, the main effect of varying kick back is flicker which is most visible in the mid-grey regions. Thus, a significant perceived improvement can be achieved without increasing the column voltage range.

Three measurement pixels 40 along a side are particularly desirable where the row conductors 17 are driven from both ends, using a further row driver circuit like the circuit 16 connected to the opposite ends of the conductors 17.

Each of the measurement pixels 40 and the processing means 55 forming the correction means in the above described embodiment is preferably generally as described in WO 2003/019520 to which reference is invited for details of their construction and operation, and whose contents are incorporated herein as reference material. This correction technique involves generating for each of the voltage polarities applied to the display elements a respective signal indicative of the capacitance of the measurement pixel and modifying the voltages generated by the drive circuit in response to those signals. Alternatively, each of the measurement pixels and the processing means of the correction means may be substantially as described in WO99/57706 and WO 2003/019509 whose contents are also incorporated herein. These use different techniques for providing a measurement representative of a DC voltage level in the display pixels. Other known kinds of measurement and correction circuits capable of providing such measurement and correction may be used instead. In WO 2003/019509 a measurement pixel comprises two dummy pixels whose display elements are driven with opposite polarity drive signals and then connected in parallel with a residual voltage, resulting from a difference in charge stored in the two display elements due to DC offset present in the elements, being measured and used to provide adjustment for subsequent drive voltages for the pixels.

Although described in relation to AMLCDs in particular, it is envisaged that the invention may be applied advantageously to other kinds of active matrix display devices.

From reading the present disclosure, other modifications will be apparent to persons skilled in the art. Such modifications may involve other features which are already known in the field of active matrix display devices and component parts therefor and which may be used instead of or in addition to features already described herein.

1. An active matrix display device comprising an array of pixels for producing a display output in response to drive voltages applied by drive circuit means, each pixel having a display element comprising electro-optical material between two electrodes and an associated switching device via which a drive voltage is applied to one electrode, the polarity of the voltage applied across the electrodes of each cell being periodically inverted, and correction means for providing a measurement indicative of a DC voltage level at the pixels and modifying voltages applied by the drive circuit means in accordance therewith so as to compensate for display artefacts caused by the DC voltage level, the correction means comprising a plurality of measurement pixels located outside the area of the array of pixels roducing the display output, the plurality of measurement pixels being arranged separate from one to another at spaced locations along at least one side of the array and the correction means being arranged to provide a measurement from each of the measurement pixels.

2. A device according to claim 1, wherein the display pixels are arranged in a row and column array and wherein a measurement pixel is arranged at each end of one side of the display pixel array which side extends parallel to the rows of display pixels.

3. A device according to claim 2, wherein a measurement pixel is arranged also at each end of the side of the pixel array opposing the one side.

4. A device according to claim 2, wherein at least one further measurement pixel is arranged spaced between the measurement pixels at the ends of the, or each, side of the array.

5. A device according to claim 1, wherein the correction means is operable to vary the modification to the drive voltages for the display pixels in the direction of the one side according to a variation in the respective measurements from each of the measurement pixels along the one side.

6. A device according to claim 1, wherein each measurement pixel comprises a plurality of interconnected dummy pixels.

7. A device according to claim 1, wherein the display elements comprise liquid crystal display elements.
